(19) United States
(12) Patent Application Publication
(10) Pub. No.: US 2025/0180473 A1
(43) Pub. Date: Jun. 5, 2025

(54) TEMPERATURE DRIFT COMPENSATION OF PHOTORESISTORS

(71) Applicant: TRINAMIX GMBH, Ludwigshafen Am Rhein (DE)

(72) Inventors: Felix SCHMIDT, Ludwigshafen am Rhein (DE); Darren GOULD, Ludwigshafen am Rhein (DE)

(21) Appl. No.: 18/873,370

(22) PCT Filed: Jul. 13, 2023
(86) PCT No.: PCT/EP23/69503

§ 371 Date: Dec. 10, 2024

(30) Foreign Application Priority Data
Jul. 14, 2022 (EP) 22184874.0

(51) Int. Cl. G01N 21/359

(52) U.S. Cl. CPC G01N 21/359; G01N 2201/1211; G01N 2201/127

(57) ABSTRACT

Disclosed herein is a method for determining at least one compensated detector signal for at least one photodetector. The at least one photodetector includes at least one detector element configured for generating at least one detector signal depending on an illumination of the at least one detector element. The method includes the following steps:
a) determining at least one dark detector resistance by using the at least one detector element and inhibiting illumination of the at least one detector element;
b) generating at least one bright detector signal by using the at least one detector element and allowing illumination of the at least one detector element; and
determining at least one compensated detector signal for compensating at least one temperature drift of the at least one detector element by using at least one evaluation unit.

Also disclosed herein are a method for determining at least one item of measurement information on at least one measurement object by using at least one photodetector, a photodetector and a spectrometer.

### TECHNICAL FIELD

The invention relates to a method for determining at least one compensated detector signal, a method for determining at least one item of measurement information on a measurement object, a photodetector and a spectrometer. Such methods and devices can, in general, be used for investigation or monitoring purposes, in particular in the infrared (IR) spectral region, especially in the near-infrared (NIR) spectral region, as well as for a detection of heat, flames, fire, or smoke. However, further kinds of applications are possible.

### BACKGROUND ART

Optical spectroscopic methods, specifically in the near- and mid-infrared spectral range, allow an insight into a molecular structure of an object by observing vibrations of molecular bonds.

While mid-infrared light can be used to excite fundamental vibrational modes having high finesse and absorption strengths, the near-infrared spectral range enables an observation of higher modes (overtones) and combination bands at lower absorption strengths. These advantages may enable to probe bulk objects and to obtain information on molecular constituents by using near-infrared spectroscopy. As a result, NIR spectroscopy can be widely applied in life and natural sciences, medicine, material science, agriculture, food, or pharmaceutical industries, e.g., for blood sugar measurements, pulse oximetry, fat content, material classification, product fraud identification, and many others.

However, providing analytical devices for the NIR wavelength range is, typically, rather difficult compared to spectrometers operating in visible light: Silicon-based light detectors are typically not applicable for light having a wavelength above 1.1 μm due to the band structure. However, indium, germanium, or lead salts or thermopiles can be applied. NIR detectors in laboratory spectrometers as well as in benchtop spectrometers are, typically, thermo-electrically cooled, often by using multiple stages, especially in order to achieve low temperatures, high detectivity and stabilization towards temperature drifts. However, thermo-electrical cooling, typically, yields technical complexity, size and power consumption, which impedes a wide-spread application of NIR spectroscopy, e.g. for point-of-care analytics, or in consumer devices.

Therefore, operation of an IR spectrometer without cooling is desired, wherein the detector materials preferably function in a wide range of operation conditions and environment temperatures. As a result, temperature-induced drifts of the detector materials need to be compensated when comparing measurements to a reference signal, or when repeating measurements in order to reduce measurement noise.

In the prior art, devices and methods are known, which apply a temperature correction based on a temperature sensor, or based on a second optical detector which is identical to the primary detector.

JP H01110225 A discloses a stable infrared radiation meter without use of a mechanical part such as a chopper, implemented by monitoring a temperature of an optical system to compensate for a temperature drift at a zero point. A detector comprising a photodiode, such as InSb and HgCdTe, is placed into a vacuum container and cooled by liquid nitrogen. Infrared rays from a measuring point form an image on a light detecting surface of the detector. A field of view of the detector is restricted by a cold shield. Temperature of an optical system is monitored by a temperature sensor to compensate for a temperature drift at the zero point of the infrared radiation meter using an output thereof.

CN 2359677 Y discloses an infrared optical fiber temperature measuring device used for smelting and casting. The infrared optical fiber temperature measuring device comprises a positioning cylinder, a hemispherical reflector, a focusing object lens, an optical fiber bundle, a filter, a detector and a temperature compensation circuit, wherein, the positioning cylinder nears the surface of melting liquid steel, and the hemispherical reflector buckles one end of the positioning cylinder above the surface of the liquid steel to be measured; the focusing object lens is installed at the top of the hemispherical reflector, one end surface of the optical fiber bundle is installed in the focal length position of the focusing objective lens, and the other end surface is coupled with the detector through the filter; the output end of the detector is connected with the temperature compensation circuit.

U.S. Pat. No. 6,852,966 B1 discloses a method and apparatus for compensating a photo-detector allowing both regulation and monitoring of the photo-detector to be performed with a common digital controller. The controller accepts input of monitored operational parameters including received signal strength and temperature. The controller provides as an output a bias control signal which regulates a positive or negative side bias voltage power supply for the photo-detector.

The controller maintains the bias voltage to the photo-detector at levels which optimize the gain and signal-to-noise ratios for the photo-detector thereby facilitating the decoding of the received signal over a broad range of signal strengths and temperatures. The controller includes a corresponding digital signal strength and temperature compensators the outputs of which summed with a summer to provide the bias control signal. The digital signal strength compensator also provides as an output a monitor signal a level of which corresponds to the actual signal strength received by the photo-detector after compensation for the variable gain of the photo-detector resulting from the bias voltage level. A transceiver as well as methods and means for monitoring a photo-detector are also disclosed.

US 20110255075 A1 discloses a spectrometric assembly and method for determining a temperature value for a detector of a spectrometer. It is conventional to record the detector temperature in an optoelectronic detector using a thermal temperature sensor in order to compensate for temperature fluctuations. Due to the finite distance between the detector and the temperature sensor, the accuracy of the temperature detection is limited. The detector temperature should be recordable at high accuracy and with little effort. In addition to means for spectral division of incident tight and an optical detector for spectrally resolved detection of a spectral range of the divided light, a second optical detector is provided for detection of a partial range of this spectral range as a reference detector, wherein sensitivity of the reference detector is substantially temperature-independent.

CN 109307550 A discloses a temperature compensation method for improving the stability of an optical power meter, and particularly relates to the technical field of temperature compensation of optical power meters. The temperature compensation method for improving the stability of the optical power meter solves the problem that the existing optical power meter without a temperature compensation device is affected by heating of the circuit itself and the temperature change of the surrounding environment when the optical power meter is used for test for a long time, which results in an increase in the test uncertainty. The temperature compensation method for improving the stability of the optical power meter comprises the following steps of: placing the optical power meter in a high-low temperature chamber, sequentially adjusting the temperature from −10° C. to 40° C., recording the zero point value of different gears at each temperature point by a CPU module, and calculating the zero drift of the current gear caused by the temperature difference according to a reference temperature; and obtaining the optical power value detected by a photoelectric detector by the CPU module, setting a current optical power detection gear, obtaining the real-time temperature detected by a temperature sensor, and sending the calibration factor of the zero drift to a secondary amplification circuit through the temperature compensation circuit by the CPU module according to the temperature drift generated by the reference temperature in the current gear for hardware circuit compensation.

JP S61213650 A discloses optical measuring equipment enabling correct measurement at all times even when wavelength for measuring is different by compensating temperature characteristic of spectral sensitivity. Radiation energy light from an object to be measured is converged by a lens and stopped down by a slit and made to parallel rays by a lens. Then, the light is spectroscopically separated by a spectroscope and is made incident onto each element of a detector as light of different wavelength. Gradient or function of the rate of variation of spectral sensitivity of measuring wavelength of each element of the detector is stored beforehand in a memory. Temperature T of the detector is detected by a temperature sensor at the time of measuring, and output of each element of the detector is calculated and corrected by an arithmetic unit basing on gradient or function of each element of the memory and temperature T of the sensor.

CN 103076087 A discloses a mid-infrared photoelectric detector driving circuit, a detector assembly and a detector assembly array. The compensation to the detector along with the drift of the ambient temperature baseline can be realized by adopting a compensation detector, which is identical with the hidden resistance characteristic of a measuring detector, and the driving circuit thereof, the change amplitude of an output baseline can be reduced, and the influence on dynamic measurement range of optical signals can be decreased; the driving circuit can also be used in both single mid-infrared photoelectric detector assembly and the mid-infrared photoelectric detector assembly array, a plurality of ways of measuring detectors can be compensated by adopting one way of compensation detector, thereby meeting the need of simultaneously measuring the detectors, and greatly lowering the production cost and decreasing the power consumption.

DE 102009026951 A1 discloses a spectroscopic gas sensor with an infrared source, an absorption chamber, an optical filter and a detector with a detector element forming a measuring beam from the infrared source through the absorption chamber and the optical filter to the detector. The detector element is arranged in the measuring beam and generates a measuring signal. The detector is a pyroelectric detector with an internal temperature compensation device which generates a temperature-compensated result signal from the measurement signal.

WO 2021/069544 A1 discloses a device (110) comprising:—at least one array (113) of photoconductors (112), wherein each photoconductor (112) is configured for exhibiting an electrical resistance de-pendent on an illumination of its light-sensitive region, wherein at least one photoconductor (112) of the array (113) is designed as characterizing photoconductor (118); —at least one bias voltage source (116), wherein the bias voltage source (116) is configured for applying at least one alternating bias voltage to the characterizing photoconductor (118) or at least one direct current (DC) bias voltage to the characterizing photoconductor (118);—at least one photo-conductor readout circuit (130), wherein the photoconductor readout circuit (130) is configured for determining of a response voltage of the characterizing photoconductor (118) generated in response to the bias voltage, wherein the response voltage is proportional to a variable characterizing the array (113) of photoconductors (112), wherein the photoconductor readout circuit (130) is configured for determining of the response voltage of the characterizing photoconductor (118) during operation of the array (113) of photoconductors (112).

G. lordache et al: “Comparative Characterization of PbS MacroAnd Nano-Crystalline Photoresistive Detectors”, Semiconductor Conference 2007, CAS 2007, IEEE, pages 199-202, describe a comparative study of photodetector performance for nano- and micro-crystalline PbS thin layers. Both types of PbS films were obtained using the Chemical Bath Deposition method. To prepare nano-crystalline thin films they used a short reaction time with no doping Bi added. At low levels of irradiance and room temperature (RT), the macro-crystalline PbS outperforms its nano-crystalline counterpart, by a factor of 6. However the nano-crystalline photodetectors show significantly lower optical quenching for large values of at RT and a performance at lower temperature, with an optimum temperature of 150 K. The low frequency noise behavior is a superposition of 1/f flicker noise at low frequency and generation-recombination and thermal noise at higher frequency. The proportionality factor between the 1/f noise and the DC dark current for the series resistor is 1.5 times larger for the nano-crystalline photodetector at room temperature.

US 2010/141768 A1 discloses methods and an apparatus for infrared imagers including fast electrostatic shutters and offset compensation. Fast electrostatic shutters are used for video image correction including image offset compensation where temporal noise and scene non uniformity are corrected. This method provides a shutterless experience for the user because the image will be blocked for only one frame at a time. A method of manufacturing an electrostatic infrared shutter includes a conductive infrared-transparent substrate, covering it with an insulating layer, depositing adhesive and a thin film stack, delineating a working area, providing contacts, heat-treating the assembly, and making the polymer non-reflective in the infrared.

“Multi-Single-Pixel thin-film encapsulated”, PbS near-infrared detector, 14 Apr. 2022, pages 1-3, is a leaflet describing PbS near-infrared detectors offered by trinamiX GmbH.

Despite the advantages as implied by the above-mentioned devices and methods, there still is a need for improvements. Specifically, additional sensors or detectors are required for compensating temperature-induced drifts of detector signals, which adds to the cost, to the complexity and thus also to the susceptibility to errors of the devices and methods. As an example, the additional detectors may fail or they may drift themselves, specifically in a different fashion compared to a primary detector.

### Problem to be Solved

Therefore, the problem addressed by the present invention is that of providing methods and devices for compensating detector signals which at least substantially avoid the disadvantages of known methods and devices of this type.

In particular, it is desirable to provide methods and devices which ensure an accurate and reliable compensation of temperature drifts of photodetectors in a simple and safe fashion, specifically without the need of installing additional components.

### SUMMARY

This problem is addressed by the invention with the features of the independent claims.

Advantageous embodiments which might be implemented in an isolated fashion or in any arbitrary combinations are listed in the dependent claims as well as throughout the specification.

In a first aspect of the present invention, a method for determining at least one compensated detector signal for at least one photodetector is disclosed. The at least one photodetector comprises at least one detector element configured for generating at least one detector signal depending on an illumination of the at least one detector element. The method comprises the following steps:
a) determining at least one dark detector resistance by using the at least one detector element and inhibiting illumination of the at least one detector element;
b) generating at least one bright detector signal by using the at least one detector element and allowing illumination of the at least one detector element; and
c) determining at least one compensated detector signal for compensating at least one temperature drift of the at least one detector element by using at least one evaluation unit for evaluating the at least one dark sensor resistance and the at least one bright detector signal.

The method steps may be performed in the indicated order. It shall be noted, however, that a different order is also possible. The method may comprise further method steps which are not listed. Further, one or more of the method steps may be performed once or repeatedly. Further, two or more of the method steps may be performed simultaneously or in a timely overlapping fashion.

The term “signal” as used herein is a broad term and is to be given its ordinary and customary meaning to a person of ordinary skill in the art and is not to be limited to a special or customized meaning. The term specifically may refer, without limitation, to an observable change in at least one physical quantity. The signal may be or comprise a sign or a function conveying information about the at least one physical quantity. The signal may specifically be or comprise at least one of an electronic signal, an optical signal or an optoelectronic signal. The signal may be a variable signal, specifically over time. The signal may be or comprise at least one of a variable voltage, a variable current, a variable charge, a variable resistance or, generally, a variable electromagnetic wave. The variable electromagnetic wave may comprise at least one of a variable amplitude, a variable frequency or a variable phase. Further options are feasible and generally known to the skilled person. The signal may specifically be generated by at least one detector. Thus, the signal may specifically be or comprise at least one detector signal.

The term “detector” as used herein is a broad term and is to be given its ordinary and customary meaning to a person of ordinary skill in the art and is not to be limited to a special or customized meaning. The term specifically may refer, without limitation, to a measurement device configured for generating at least one measurement signal related to at least one measurement object. The detector may be an electronic device or an optoelectronic device. The detector may be configured for generating at least one electronic signal, such as e.g. a current or a voltage.

The detector may specifically be a photodetector. The term “photodetector” as used herein is a broad term and is to be given its ordinary and customary meaning to a person of ordinary skill in the art and is not to be limited to a special or customized meaning. The term specifically may refer, without limitation, to an optical detector or sensor configured for detecting optical radiation, such as for detecting an illumination and/or a light spot generated by at least one light beam. The photodetector may comprise at least one substrate. A single photodetector may be a substrate with at least one single photosensitive area, which generates a physical response to the illumination for a given wavelength range. As said, the photodetector comprises at least one detector element. The photodetector may comprise a plurality of detector elements, which may be arranged in at least one of an array or a matrix. The term “detector element” as used herein is a broad term and is to be given its ordinary and customary meaning to a person of ordinary skill in the art and is not to be limited to a special or customized meaning. The term specifically may refer, without limitation, to a unit of a photosensitive area of the photodetector. The detector element be configured for being illuminated, or in other words for receiving optical radiation, and for generating at least one detector signal in response to the illumination. The detector element may be located on a surface of the photodetector. The detector element may specifically be a single, closed, uniform photosensitive area. However, other options may also be feasible.

The term “detector signal” as used herein is a broad term and is to be given its ordinary and customary meaning to a person of ordinary skill in the art and is not to be limited to a special or customized meaning. The term specifically may refer, without limitation, to a signal generated by at least one of at least one detector or at least a part of a detector. Specifically, the detector signal may be generated by a detector element of a photodetector in accordance with the present invention. As will be outlined in further detail below, the detector signal may be or comprise at least one of a dark detector signal or a bright detector signal. The detector signal may be or comprise at least one signal generated by a detector at a single point in time. The detector signal may be or comprise at least one signal generated by a detector over a time period. The detector signal may be or comprise at least one preprocessed detector signal, such as a filtered or smoothened or amplified detector signal. The detector signal may be or comprise at least one of an analog signal or a digital signal. Specifically, the detector signal may be or comprise at least one compensated detector signal.

The term “compensation” including any grammatical variation thereof as used herein is a broad term and is to be given its ordinary and customary meaning to a person of ordinary skill in the art and is not to be limited to a special or customized meaning. The term specifically may refer, without limitation, to a cancellation or a correction of a physical effect, specifically of a disturbing influence or interference or perturbation. The compensation may be or may comprise a measure against the perturbation. Specifically, the compensation may be a temperature compensation, wherein the temperature, or more specifically temperature variations, may be a perturbation, e.g. for a detector. As an example, a responsivity of a photodetector, or more specifically of a detector element, may be temperature dependent. Thus, variations of an environmental temperature of the detector element may lead to additional variations of the detector signal which are not responsive to an illumination of the photodetector. In other words, the detector signal may be subject to a temperature drift. The term “temperature drift” as used herein is a broad term and is to be given its ordinary and customary meaning to a person of ordinary skill in the art and is not to be limited to a special or customized meaning. The term specifically may refer, without limitation, to a temperature-induced change of an entity, specifically of the detector signal. More specifically, the temperature drift may be induced by a variation of a temperature of the detector element. The temperature drift may typically be undesirable when measuring the illumination impinging the detector element, specifically for reliable and accurate high-precision measurements. Generally, besides the temperature, further perturbations of the detector signal may in principle also be conceivable, such as variations in a background illumination.

The term “compensated detector signal” as used herein is a broad term and is to be given its ordinary and customary meaning to a person of ordinary skill in the art and is not to be limited to a special or customized meaning. The term specifically may refer, without limitation, to a detector signal in which at least one perturbation of the detector signal, specifically a temperature drift, is corrected or cancelled. Specifically, the compensated detector signal may comprise information about the illumination impinging the detector element only. Additional variations in the detector signal, specifically due to temperature variations of the detector element, may be cancelled out in the compensated detector signal.

The term “illumination” as used herein is a broad term and is to be given its ordinary and customary meaning to a person of ordinary skill in the art and is not to be limited to a special or customized meaning. The term specifically may refer, without limitation, to optical radiation, specifically within at least one of the visible, the ultraviolet or the infrared spectral range. The term “ultraviolet”, generally, refers to electromagnetic radiation having a wavelength of 1 nm to 380 nm, preferably of 100 nm to 380 nm. Further, the term “visible”, generally, refers to a wavelength of 380 nm to 760 nm. Further, the term “infrared”, “abbreviated to IR”, generally refers to a wavelength of 760 nm to 1000 μm, wherein the wavelength of 760 nm to 3 μm is, usually, denominated as “near infrared”, abbreviated to “NIR”. Preferably, the illumination which is used for typical purposes of the present invention is IR radiation, more preferred, in NIR radiation, especially of a wavelength of 760 nm to 3 μm, preferably of 1 μm to 3 μm. The illumination may specifically be optical radiation impinging the photodetector, or more specifically the detector element. The illumination may be provided by at least one measurement object, wherein the providing may comprise at least one of a reflecting, transmitting and emitting. Before interacting with the measurement object, the illumination may e.g. be emitted by at least one radiation emitting element such as at least one of a semiconductor-based radiation source or a thermal radiator. The illumination may be modulated, e.g. by using a modulated radiation emitting element. The term “illumination” may also be referred to as “optical radiation” or as “light” herein.

Step a) comprises determining at least one dark detector resistance by using the at least one detector element and inhibiting illumination of the at least one detector element. The term “inhibiting illumination” as used herein is a broad term and is to be given its ordinary and customary meaning to a person of ordinary skill in the art and is not to be limited to a special or customized meaning. The term specifically may refer, without limitation, to preventing or impeding or blocking illumination of an entity, specifically of the detector element. The detector element may not be illuminated for inhibiting the illumination. As an example, a radiation emitting element may be turned off or paused for inhibiting the illumination. Additionally or alternatively, the detector element may be covered for inhibiting the illumination. As an example, the photodetector may comprise at least one cover, e.g. a shutter, configured for at least temporarily covering the detector element. Step a) may comprise covering the at least one detector element with at least one object, such as a cover, e.g. a shutter. Further options for inhibiting illumination of the detector element may be feasible.

Without being illuminated, the at least one detector element may be configured for generating at least one dark detector signal. The term “dark detector signal” as used herein is a broad term and is to be given its ordinary and customary meaning to a person of ordinary skill in the art and is not to be limited to a special or customized meaning. The term specifically may refer, without limitation, to a signal generated by the at least one detector element, wherein an illumination of the detector element is inhibited when generating the signal. The dark detector signal may be independent of an illumination of the detector element. The dark detector signal may be dependent on at least one intrinsic property of the detector element, specifically a material property of at least one semiconductor comprised by the detector element. The dark detector signal may specifically be dependent on a temperature of the detector element. As an example, the dark detector signal may comprise a dark detector current. The dark detector current may be thermally induced by a spontaneous formation of free charge carriers within a semiconductor comprised by the dark detector. The dark detector signal may specifically comprise a dark detector resistance.

The term “dark detector resistance” as used herein is a broad term and is to be given its ordinary and customary meaning to a person of ordinary skill in the art and is not to be limited to a special or customized meaning. The term specifically may refer, without limitation, to a resistance of the at least one detector element in a state in which an illumination of the at least one detector element is inhibited. In other words, the dark detector resistance may be a resistance of an unilluminated detector element. The dark detector resistance may be independent of an illumination of the at least one detector element. The dark detector resistance may be dependent on at least one intrinsic property of the at least one detector element, specifically a material property of at least one semiconductor comprised by the at least one detector element. The dark detector resistance may specifically be dependent on a temperature of the at least one detector element. As generally known by the skilled person, a conductivity of a material is typically dependent on the number of free charge carriers within the material. Thus, when a number of free charge carriers in a material changes, e.g. thermally induced as already mentioned above or also light induced, the conductivity of the material typically also changes.

Step b) comprises generating at least one bright detector signal by using the at least one detector element and allowing illumination of the at least one detector element. The term “allowing illumination” as used herein is a broad term and is to be given its ordinary and customary meaning to a person of ordinary skill in the art and is not to be limited to a special or customized meaning. The term specifically may refer, without limitation, to permitting or enabling illumination of an entity, specifically of the at least one detector element. As indicated, the at least one detector element may be illuminated by e.g. using a radiation emitting element for allowing the illumination. The at least one detector element may be uncovered for allowing the illumination. A beam path to the at least one detector element may be free of objects blocking the illumination.

When illuminated, the at least one detector element may be configured for generating at least one bright detector signal. The term “bright detector signal” as used herein is a broad term and is to be given its ordinary and customary meaning to a person of ordinary skill in the art and is not to be limited to a special or customized meaning. The term specifically may refer, without limitation, to a signal generated by the at least one detector element, wherein an illumination of the detector element is allowed when generating the signal. In other words, the bright detector signal may be generated by an illuminated detector element. The bright detector signal may be dependent on an illumination of the at least one detector element. The bright detector signal may comprise a photocurrent. The bright detector signal may comprise a bright detector resistance. As indicated, a change in a number of free charge carriers may also be induced by an illumination. The bright detector signal may further be dependent on at least one intrinsic property of the detector element, specifically a material property of at least one semiconductor comprised by the detector element. The bright detector signal may be dependent on a temperature of the detector element. Thus, the bright detector signal may be prone to a temperature drift.

As indicated, the at least one detector signal as generated by the at least one detector element may comprise at least one of a bright detector signal or a dark detector signal. As an example, a modulated radiation emitting element may be used for analyzing a measurement object by using a photodetector comprising a detector element. The detector signal may be a signal as generated by the detector element over a time period. Thus, the detector signal may also be a modulated signal, such as a periodic signal comprising maxima and minima. The maxima of the detector signal may refer to a bright detector signal. The minima of the detector signal may refer to a dark detector signal.

Step c) comprises determining at least one compensated detector signal for compensating at least one temperature drift of the at least one detector element by using at least one evaluation unit for evaluating the at least one dark sensor resistance and the at least one bright detector signal. The term “evaluation” including any grammatical variation thereof as used herein is a broad term and is to be given its ordinary and customary meaning to a person of ordinary skill in the art and is not to be limited to a special or customized meaning. The term specifically may refer, without limitation, to analyzing or interpreting data, specifically for determining at least one item of qualitative or quantitative information. The evaluation may comprise processing the data, such as by using at least one relation, specifically at least one function having at least one of a variable or a predetermined parameter.

The term “evaluation unit” as used herein is a broad term and is to be given its ordinary and customary meaning to a person of ordinary skill in the art and is not to be limited to a special or customized meaning. The term specifically may refer, without limitation, to a device configured for analyzing or interpreting data, specifically for determining at least one item of qualitative or quantitative information. The information may specifically be obtained by evaluating at least one detector signal generated by the at least one detector element. The evaluation unit may be or may comprise at least one of an integrated circuit, in particular an application-specific integrated circuit (ASIC), or a data processing device, in particular at least one of a digital signal processor (DSP), a field programmable gate array (FPGA), a microcontroller, a microcomputer, a computer, or an electronic communication unit, specifically a smartphone or a tablet. Further components may be feasible, in particular at least one preprocessing device or data acquisition device. Further, the evaluation unit may comprise at least one interface, in particular at least one of a wireless interface or a wire-bound interface. Further, the evaluation unit can be designed to, completely or partially, control or drive further devices, such as the at least one photodetector. The evaluation unit can, in particular, be designed to carry out at least one measurement cycle in which a plurality of detector signals may be picked up. The information as determined by the evaluation unit may, in particular, be provided to at least one of a further apparatus, or to a user, preferably in at least one of an electronic, visual, acoustic, or tactile fashion. Further, the information may be stored in at least one data storage unit, specifically in an internal data storage unit as comprised by the spectral sensing device, in particular by the at least one evaluation unit, or in an separate storage unit to which the information may be transmitted via the at least one interface. The separate storage unit may be comprised by the at least one electronic communication unit. The storage unit may in particular be configured for storing at least one electronic table, such as at least one look-up table.

The evaluation unit may, preferably, be configured to perform at least one computer program, in particular at least one computer program performing or supporting the step of generating the at information. By way of example, one or more algorithms may be implemented which, by using the at least one detector signal as at least one input variable, may perform a transformation into a piece of information. For this purpose, the evaluation unit may, particularly, comprise at least one data processing device, in particular at least one of an electronic or an optical data processing device, which can be designed to generate the information by evaluating the at least one detector signal. Thus, the evaluation unit may be designed to use at least one detector signal as the at least one input variable and to generate the information by processing the at least one input variable. The processing can be performed in a consecutive, a parallel, or a combined manner. The evaluation unit may use an arbitrary process for generating the information, in particular by calculation and/or using at least one stored and/or known relationship.

The at least one photodetector may comprise at least one of the evaluation unit or a communication interface. The communication interface may be configured for transmitting data at least one of from or to or within the evaluation unit. The term “communication interface” as used herein is a broad term and is to be given its ordinary and customary meaning to a person of ordinary skill in the art and is not to be limited to a special or customized meaning. The term specifically may refer, without limitation, to an item or element forming a boundary configured for transferring information. In particular, the communication interface may be configured for transferring information from a computational device, e.g. a computer, such as to send or output information, e.g. onto another device. Additionally or alternatively, the communication interface may be configured for transferring information onto a computational device, e.g. onto a computer, such as to receive information. The communication interface may specifically provide means for transferring or exchanging information. In particular, the communication interface may provide a data transfer connection, e.g. Bluetooth, NFC, inductive coupling or the like. As an example, the communication interface may be or may comprise at least one port comprising one or more of a network or internet port, a USB-port and a disk drive. The communication interface may comprise at least one web interface.

The at least one evaluation unit may be at least partially cloud-based. The term “cloud-based” as used herein is a broad term and is to be given its ordinary and customary meaning to a person of ordinary skill in the art and is not to be limited to a special or customized meaning. The term specifically may refer, without limitation, to an outsourcing of the at least one evaluation unit or of at least a part thereof to at least partially interconnected external devices, specifically computers or computer networks having larger computing power and/or data storage volume. The external devices may be arbitrarily spatially distributed. The external devices may vary over time, specifically on demand. The external devices may be interconnected by using the internet. The external devices may each comprise at least one communication interface.

In step c), the at least one compensated detector signal may be determined by using Equation (1):

$${S}_{comp} ( {T}_{0} , λ ) = S ( {T}_{0} + Δ T , λ ) ( 1 - \frac{Γ {γ}_{R} Δ T}{α ( {T}_{0} , λ ) + {Γγ}_{R} Δ T} ) , \qquad ( 1 )$$

wherein S_{comp} (T₀,λ) refers to the compensated detector signal at a first temperature T₀ of the at least one detector element, wherein λ refers to a wavelength of optical radiation illuminating the at least one detector element, wherein S(T₀+ΔT,λ) refers to a bright detector signal at a second temperature T₀+ΔT of the at least one detector element, wherein ΔT refers to a temperature change of the at least one detector element, wherein α(T₀,λ) refers to a resistive responsivity of the at least one detector element at the first temperature T₀ of the at least one detector element, wherein Γ is defined as

$$Γ = \frac{{γ}_{α}}{{γ}_{R}} ,$$

wherein γ_{α} refers to a predetermined resistive responsivity coefficient of the at least one detector element, and wherein γ_{R} refers to a predetermined dark resistance coefficient of the at least one detector element. In other words, the bright detector signal may be measured after a, typically undesired, temperature change ΔT of the detector element, wherein the temperature change ΔT may induce a temperature drift of the bright detector signal. However, the temperature drift may be compensated by using Equation (1) for deriving accurate and reliable measurement results.

The term “responsivity” as used herein is a broad term and is to be given its ordinary and customary meaning to a person of ordinary skill in the art and is not to be limited to a special or customized meaning. The term specifically may refer, without limitation, to a relation between at least one input and at least one output of a detector. The responsivity may be an input-output gain of the detector. In accordance with the at least one photodetector or more specifically the at least one detector element of the present invention, the responsivity may be a relation between an optical input and an electrical output. In other words, the responsivity may measure the electrical output, e.g. a photocurrent or a resistance, per optical input, e.g. an illumination intensity or irradiance. The responsivity may also be referred to as photosensitivity. The term “resistive responsivity” as used herein is a broad term and is to be given its ordinary and customary meaning to a person of ordinary skill in the art and is not to be limited to a special or customized meaning. The term specifically may refer, without limitation, to a relation between an input spectral irradiance I(λ) and an overall output resistance R of the at least one detector element. In other words, the resistive responsivity may relate the spectral irradiance of the illumination impinging the at least one detector element to the consequently induced resistance of the at least one detector element. In a linear approximation, the resistance of the at least one detector element may be described according to the following equation by using the resistive responsivity a of the at least one detector element:

$$R ( I , T , λ ) = {R}_{D} ( T ) + α ( T , λ ) I ( λ ) ,$$

wherein R_{D}(T) refers to the temperature-dependent dark resistance of the at least one detector element, wherein T generally refers to a temperature. The resistive responsivity α(T,λ) of the at least one detector element may be at least one of temperature-dependent or wavelength-dependent. In principle, non-linear responses, e.g. quadratic factors or cubic factors, may additionally be used for higher order approximations of the resistance.

The term “resistive responsivity coefficient”, also referred to as γ_{α}, as used herein is a broad term and is to be given its ordinary and customary meaning to a person of ordinary skill in the art and is not to be limited to a special or customized meaning. The term specifically may refer, without limitation, to a coefficient used for determining, or at least approximating, the resistive responsivity of the at least one detector element after a temperature change ΔT of the at least one detector element based on the temperature change ΔT. In a linear approximation, the resistive responsivity of the at least one detector element may be described according to the following equation by using the resistive responsivity coefficient:

$$α ( {T}_{0} + Δ T , λ ) = α ( {T}_{0} ) + {γ}_{α} Δ T .$$

The term “dark resistance coefficient”, also referred to as γ_{R}, as used herein is a broad term and is to be given its ordinary and customary meaning to a person of ordinary skill in the art and is not to be limited to a special or customized meaning. The term specifically may refer, without limitation, to a coefficient used for determining, or at least approximating, the dark resistance of the at least one detector element after a temperature change ΔT of the at least one detector element based on the temperature change ΔT. In a linear approximation, the resistive responsivity of the at least one detector element may be described according to the following equation by using the dark resistance coefficient:

$${R}_{D} ( {T}_{0} + Δ T ) = {R}_{D} ( {T}_{0} ) + {γ}_{R} Δ T .$$

In principle, non-linear dependencies, e.g. quadratic factors or cubic factors, may additionally be used for higher order approximations of at least one of the dark resistance or the resistive responsivity. However, the non-linear dependencies may be negligible, specifically for small temperature changes ΔT of the at least one detector element, more specifically for ΔT<T₀. ΔT may be below 10 K, specifically below 1 K, more specifically below 0.1 K.

At least one of γ_{α} or γ_{R} may be predetermined in at least one calibration process of the at least one detector element. The term “calibration” as used herein is a broad term and is to be given its ordinary and customary meaning to a person of ordinary skill in the art and is not to be limited to a special or customized meaning. The term specifically may refer, without limitation, to a process for initially predetermining measurement characteristics or conditions of a measurement device, specifically of the at least one photodetector, more specifically of the at least one detector element. As an example, at least one reference having known physical properties may be used for the calibration, specifically for comparing measurement results to the known properties. The calibration may further refer to a process for ensuring the predetermining measurement characteristics or conditions, which may be performed regularly or irregularly after an initial calibration. The calibration may comprise adjusting or correcting the measurement characteristics or conditions, e.g. in accordance with known physical properties of at least one reference. This may allow enhancing robustness, reliability and accuracy of the measurement. γ_{R}ΔT, as e.g. used as a term in Equation (1), may be determined by using at least one baseline of the at least one detector element. The term “baseline” as used herein is a broad term and is to be given its ordinary and customary meaning to a person of ordinary skill in the art and is not to be limited to a special or customized meaning. The term specifically may refer, without limitation, to a line or a curve representing a minimum signal, such as a minimum signal intensity or a minimum signal count. The baseline may be or comprise an interpolation of minima of a variable signal, such as of a periodic signal. The baseline may be or comprise a function fit to the minima of the variable signal. As already indicated in a previous example, a modulated radiation emitting element may be used for analyzing a measurement object by using a photodetector comprising a detector element. Thus, the detector signal generated by the at least one detector element over a selected time period may also be a modulated signal.

The maxima of the detector signal may refer to a bright detector signal. The minima of the detector signal may refer to a dark detector signal. The baseline may be an interpolation of the minima of the detector signal. Further options may be feasible. Generally, the at least one baseline may be determined by using at least one dark detector signal. The at least one baseline may be determined by using the at least one dark detector resistance. γ_{R}ΔT, as e.g. used as a term in Equation (1), may be determined by using the at least one dark detector resistance. γ_{R}ΔT may be determined by using Equation (2):

$${γ}_{R} Δ T = {R}_{D} ( {T}_{0} + Δ T ) - {R}_{D} ( {T}_{0} ) , \qquad ( 2 )$$

wherein R_{D} refers to the at least one dark detector resistance. Equivalent to this, the temperature change ΔT can determined by using Equation (3):

$$Δ T = \frac{{R}_{D} ( {T}_{0} + Δ T ) - {R}_{D} ( {T}_{0} )}{{γ}_{R}} . \qquad ( 3 )$$

Thus, the temperature change ΔT may determined by measuring the at least one dark detector resistance R_{D} of the at least one detector element or more specifically a change of the at least one dark detector resistance R_{D} of the at least one detector element. This may avoid using further measurement devices such as additional optical detectors or temperature sensors for exclusively measuring the temperature. Determining the at least one dark detector resistance of the at least one detector element may typically already be part of a measurement routine, such that it may typically not represent any extra effort. In any case, the at least one dark detector resistance of the at least one detector element may typically be easily accessible or determinable, such that measurements of the at least one dark detector resistance may be easily applicable. Thus, a reliable compensation of temperature drifts of photodetectors may be achievable in a simple and safe fashion, specifically without the need of installing additional components.

Γ, as e.g. used in Equation (1), may be predetermined in a calibration process of at least one of the at least one detector element or at least one further detector element. The at least one detector element and the at least one further detector element may be selected from an identical class of detector elements. In other words, a calibration of each individual used detector element may be avoidable. Instead, using a detector element for calibration which is merely of the same class may be sufficient. This may further facilitate compensation of the temperature drifts. F may be a universal factor, at least for a selected class of detector elements, since the resistive responsivity coefficient and the dark resistance coefficient typically show a fundamental linear dependence as will be outlined in further detail below with respect to experimental data. Between different classes of detector elements, Γ may vary. The term “class of detector elements” as used herein is a broad term and is to be given its ordinary and customary meaning to a person of ordinary skill in the art and is not to be limited to a special or customized meaning. The term specifically may refer, without limitation, to a type or group of detector elements, which are essentially identical. A class of detector elements may comprise a plurality of detector elements having an identical architecture or layout. Minor differences, such as manufacturing-related differences, may be negligible. Specifically, a class of detector elements may comprise a plurality of detector elements comprising the same photosensitive material.

The method for determining at least one detector signal may at least partially be computer-implemented. Referring to the computer-implemented aspects of the invention, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

In a further aspect of the present invention, a method for determining at least one item of information on at least one measurement object is disclosed. The at least one photodetector comprises at least one detector element configured for generating at least one detector signal depending on an illumination of the at least one detector element. The method comprises the following steps:
i) providing optical radiation by using the at least one measurement object and generating at least one detector signal by using the at least one photodetector;
ii) determining at least one compensated detector signal according to any one of the embodiments described above or below in further detail referring to a method for determining at least one compensated detector signal; and
iii) determining at least one item of measurement information on the at least one measurement object by using the at least one compensated detector signal.

The method steps may be performed in the indicated order. It shall be noted, however, that a different order is also possible. The method may comprise further method steps which are not listed. Further, one or more of the method steps may be performed once or repeatedly. Further, two or more of the method steps may be performed simultaneously or in a timely overlapping fashion.

The term “item of measurement information” as used herein is a broad term and is to be given its ordinary and customary meaning to a person of ordinary skill in the art and is not to be limited to a special or customized meaning. The term specifically may refer, without limitation, to knowledge or evidence providing a qualitative and/or quantitative description relating to at least one measurement, specifically to the at least one measurement object. The item of measurement information may comprise at least one of a physical property of the measurement object or a chemical composition of the at least one measurement object. The physical property may specifically comprise an optical property such at least one absorbance of the measurement object and/or at least one emissivity of the measurement object. The chemical composition may specifically refer to qualitative and/or quantitative information on at least one material the measurement object comprises.

The term “measurement object” as used herein is a broad term and is to be given its ordinary and customary meaning to a person of ordinary skill in the art and is not to be limited to a special or customized meaning. The term specifically may refer, without limitation, to an arbitrary body, chosen from a living body and a non-living body. The measurement object may specifically comprise at least one material which is subject to an investigation. The measurement object may generally refer to an object which is to be measured, e.g. for which a spectrum is to be recorded, wherein the measurement object may have in principle arbitrary properties, e.g. arbitrary optical properties or an arbitrary shape. The measurement object may comprise at least one solid sample. However, other measurement objects such as fluids may also be feasible.

In step i), the optical radiation provided by the at least one measurement object may comprise a wavelength of 300 nm to 3000 nm, specifically 500 nm to 2500 nm, more specifically 1400 nm to 2000 nm. The term “providing” including any grammatical variation thereof as used herein is a broad term and is to be given its ordinary and customary meaning to a person of ordinary skill in the art and is not to be limited to a special or customized meaning. The term specifically may refer, without limitation, to at least one of reflecting, specifically diffusely; diffracting; transmitting and emitting optical radiation. The optical radiation provided by the measurement object may be indicative of at least one of a physical property of the measurement object, e.g. an optical property and/or a temperature of the measurement object, and a chemical property of the measurement object, e.g. a chemical composition of the measurement object. As an example, the optical radiation provided by the measurement object may be emitted by the at least one measurement object, specifically at least partially towards the at least one photodetector. Further, the optical radiation provided by the at least one measurement object may be reflected by the at least one measurement object at least partially towards the at least one photodetector, e.g. diffusely. Further, the optical radiation provided by the at least one measurement object may be transmitted through the at least one measurement object at least partially towards the at least one photodetector. However, the at least one measurement object may also at least partially absorb the optical radiation, which may specifically be indicative of at least one physical property of the at least one measurement object and/or at least one chemical property of the at least one measurement object such as a chemical composition of at least one material forming the at least one measurement object.

As said, step iii) comprises determining at least one item of measurement information on the at least one measurement object by using the at least one compensated detector signal, specifically as the at least one compensated detector signal determined in step ii). As already discussed, the at least one detector signal generated by the at least one detector element may drift. Specifically the at least one detector signal may be affected by a temperature drift. Thus, using the at least one detector signal directly for determining the at least one item of measurement information may be inaccurate. Consequently, specifically for high-precision measurements, the at least one detector signal should typically be corrected before determining the at least one item of measurement information. For this reason, the at least one compensated detector signal may specifically be used for determining the at least one item of measurement information on the at least one measurement object, e.g. by further evaluating the at least one compensated detector signal, such as by using the at least one evaluation unit. The at least one evaluation unit may be configured for determining the at least one item of measurement information on the at least one measurement object by using the at least one compensated detector signal.

The method for determining at least one item of measurement information may at least partially be computer-implemented. Referring to the computer-implemented aspects of the invention, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

For further details regarding to the method for determining at least one item of measurement information, reference may be made to the description of the method for determining at least one compensated detector signal.

In a further aspect of the present invention, a computer program is disclosed. The computer program comprises instructions which, when the computer program is executed by a computer, cause the computer to carry out at least one of the methods according to any one of the embodiments described above or below in further detail referring to a method.

In a further aspect of the present invention, a non-transient computer-readable medium is disclosed. The non-transient computer-readable medium includes instructions that, when executed by one or more processors, cause the one or more processors to perform at least one of the methods according to any one of the embodiments described above or below in further detail referring to a method.

In a further aspect of the present invention, a photodetector for measuring optical radiation is disclosed. The photodetector is configured for performing at least one method according to any one of the embodiments described above or below in further detail referring to at least one of
a method for determining at least one compensated detector signal of at least one photodetector; or
a method for determining at least one item of information on at least one measurement object.

The photodetector comprises at least one detector element.

The photodetector may further comprise at least one readout circuit configured for reading out the at least one detector signal. The term “readout” as used herein is a broad term and is to be given its ordinary and customary meaning to a person of ordinary skill in the art and is not to be limited to a special or customized meaning. The term specifically may refer, without limitation, to an action or process of quantifying and/or processing at least one physical property and/or a change in at least one physical property detected by at least one device, specifically by at least one measurement device such as the at least one photodetector or more specifically the at least one detector element. The readout may comprise an individual readout of one device such as of one detector element. Additionally or alternatively, the readout may comprise a readout of a group of devices such as a group of detector elements. The term “readout circuit” as used herein is a broad term and is to be given its ordinary and customary meaning to a person of ordinary skill in the art and is not to be limited to a special or customized meaning. The term specifically may refer, without limitation, to an electric circuit configured for quantifying and/or processing at least one physical property and/or a change in at least one physical property detected by at least one measurement device such as the at least one photodetector or more specifically the at least one detector element. The readout circuit may be configured for reading out the at least one photodetector. The readout-circuit may be configured for reading out the at least one detector element. The at least one readout circuit may comprise at least one resistance meter configured for measuring at least one resistance of the at least one detector element, such as at least one dark detector resistance or a bright detector resistance.

The at least one detector element may comprise at least one photoconductive material. The photoconductive material may be selected from at least one of PbS, PbSe, Ge, InGaAs, InSb, or HgCdTe. The detector element may be configured as a photoconductor or photodiode. The detector element may be optically active. The detector element may generate an electrical signal when illuminated. An integrated circuit may condition, amplify and/or digitize an optically induced electrical signal. The at least one photodetector may comprise at least one of an evaluation unit or a communication interface configured for transmitting data at least one of from or to or within the evaluation unit. The at least one evaluation unit may be at least partially cloud-based. The at least one readout circuit, specifically the at least one resistance meter, may be, specifically wired, to at least one of the at least one evaluation unit or the at least one communication interface.

For further details regarding to the photodetector, reference may be made to the description of the method for determining at least one compensated detector signal or the method for determining at least one item of measurement information.

In a further aspect of the present invention, a spectrometer for spectrally analyzing optical radiation provided by at least one measurement object is disclosed. The spectrometer comprises:
at least one radiation emitting element configured for emitting optical radiation at least partially towards the at least one measurement object; and
at least one photodetector according to any one of the embodiments described above or below in further detail referring to a photodetector.

The term “spectrum” including an grammatical variation thereof as used herein is a broad term and is to be given its ordinary and customary meaning to a person of ordinary skill in the art and is not to be limited to a special or customized meaning. The term specifically may refer, without limitation, to a partition of the optical radiation, wherein the spectrum is constituted by an optical signal defined by a signal wavelength and a corresponding signal intensity. In particular, the spectrum may comprise spectral information related to at least one measurement object, such as a type and composition of at least one material forming the at least one measurement object, which can be determined by recording at least one spectrum related to the at least one measurement object. The term “spectrometer” as used herein is a broad term and is to be given its ordinary and customary meaning to a person of ordinary skill in the art and is not to be limited to a special or customized meaning. The term specifically may refer, without limitation, to an apparatus which is configured for determining spectral information by recording at least one measured value for at least one signal intensity related to at least one corresponding signal wavelength of optical radiation and by evaluating at least one detector signal which relates to the signal intensity.

The term “radiation emitting element” as used herein is a broad term and is to be given its ordinary and customary meaning to a person of ordinary skill in the art and is not to be limited to a special or customized meaning. The term specifically may refer, without limitation, to a device configured for emitting optical radiation. As an example, the at least one radiation emitting element may be configured for emitting a light beam towards the at least one measurement object. However, the at least one radiation emitting element may also be configured for isotopically emitting optical radiation, e.g. uniformly in all spatial directions, wherein only a part of the emitted optical radiation may impinge the at least one measurement object. The at least one radiation emitting element may comprise at least one of a semiconductor-based radiation source or a thermal radiator. The at least one semiconductor-based radiation source may be selected from at least one of a light emitting diode (LED) or a laser, specifically a laser diode. Further kinds of radiation emitting elements may also be feasible.

The spectrometer may further comprise at least one temperature stabilizing element, specifically a thermoelectric cooler. The term “temperature stabilizing element” as used herein is a broad term and is to be given its ordinary and customary meaning to a person of ordinary skill in the art and is not to be limited to a special or customized meaning. The term specifically may refer, without limitation, to an element or device configured for keeping a temperature of a further element or device constant or steady or stable. Specifically, the at least one temperature stabilizing element may be configured for stabilizing the temperature of the at least one detector element. The at least one temperature stabilizing element may be configured for keeping the temperature of the at least one detector element at a predetermined level. However, the at least one temperature stabilizing element may also be configured for stabilizing the temperature of further components of the spectrometer, such as the at least radiation emitting element or components surrounding at least one of the at least one detector element or the at least one radiation emitting element. The at least one temperature stabilizing element may be or comprise at last one thermoelectric cooler.

The term “thermoelectric cooler” as used herein is a broad term and is to be given its ordinary and customary meaning to a person of ordinary skill in the art and is not to be limited to a special or customized meaning. The term specifically may refer, without limitation, to an electrically driven heat pump configured for transferring heat between at least two spatial areas, thereby generating a heat flux between the at least two spatial areas. The thermoelectric cooler may, specifically, be based on the Peltier effect in order to create the heat flux. For this purpose, the thermoelectric cooler may, especially, comprise at least one Peltier element. A direction of the heat flux may depend on a direction of an electrical current applied to the thermoelectric cooler. Depending on the direction of the heat flux, the thermoelectric cooler can be used for cooling at least one spatial area by transferring heat to at least one further spatial area, or for heating the at least one spatial area by transferring heat from the at least one further spatial area. Other options may also be feasible.

The at least one evaluation unit may further be designed to, completely or partially, control or drive the spectrometer or a part thereof, such as the radiation emitting element. As said, the at least one photodetector may comprise the at least one evaluation unit. However, the evaluation unit may also be at least partially arranged outside the at least one photodetector, such as in the spectrometer. Thus, the spectrometer may comprise the at least one evaluation unit.

Additionally or alternatively, the at least one evaluation unit may at least partially be arranged outside of the spectrometer, such as in an external device, e.g. a computer, a smartphone or a tablet. As said, the evaluation unit may at least partially be cloud-based. The spectrometer may comprise at least one communication interface for configured for transmitting data at least one of from or to or within the evaluation unit.

The spectrometer may further comprise at least one filter element configured for filtering the optical radiation or more specifically selected wavelengths of the optical radiation. The at least one filter element may specifically be positioned in a beam path before the at least one detector element. The spectrometer may comprise a plurality of detector elements and a plurality of filter elements, wherein at least one filter element may be positioned in a beam path before at least one detector element, wherein the plurality of filter elements may be configured for at least partially filtering different wavelengths.

For further details regarding to the spectrometer, reference may be made to the description of the photodetector, the method for determining at least one compensated detector signal or the method for determining at least one item of measurement information.

In a further aspect of the present invention, a use of at least one of a method for determining at least one item of information on a measurement object according to any one of the embodiments described above or below in further detail referring to a method for determining at least one item of information on a measurement object or a spectrometer according to any one of the described above or below in further detail referring to a spectrometer is disclosed for a purpose of use, selected from the group consisting of: an infrared detection application; a spectroscopy application; an exhaust gas monitoring application; a combustion process monitoring application; a pollution monitoring application; an industrial process monitoring application; a mixing or blending process monitoring; a chemical process monitoring application; a food processing process monitoring application; a food preparation process monitoring; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application, in particular characterization of soil, silage, feed, crop or produce, monitoring plant health; a plastics identification and/or recycling application; and a textiles identification and recycling application.

The methods and devices as disclosed herein have considerable advantages over the prior art. Specifically, the methods and devices disclosed herein may ensure an accurate and reliable compensation of temperature drifts of photodetectors in a simple and safe fashion. They may specifically avoid using additional components such as temperature sensors or additional optical detectors for compensating the temperature drift, which may typically reflect in cost, complexity and susceptibility to errors. Instead, they may use measurements of the dark detector resistance of the detector element, which may already be part of a typical measurement routine or which may at least be easy to be implemented. By using a fundamental linear dependence between the resistive responsivity coefficient and the dark resistance coefficient, a calibration process may further be facilitated. Specifically, calibration of each used detector element may be avoided, such that a factory calibration of the detector element type may be sufficient. Thus, the methods and devices as disclosed herein may also be suitable for everyday users without special training.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, notwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way.

The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

Summarizing and without excluding further possible embodiments, the following embodiments may be envisaged:

Embodiment 1: A method for determining at least one compensated detector signal for at least one photodetector, wherein the at least one photodetector comprises at least one detector element configured for generating at least one detector signal depending on an illumination of the at least one detector element, the method comprising the following steps:
a) determining at least one dark detector resistance by using the at least one detector element and inhibiting illumination of the at least one detector element;
b) generating at least one bright detector signal by using the at least one detector element and allowing illumination of the at least one detector element; and
c) determining at least one compensated detector signal for compensating at least one temperature drift of the at least one detector element by using at least one evaluation unit for evaluating the at least one dark sensor resistance and the at least one bright detector signal.

Embodiment 2: The method according to the preceding Embodiment, wherein in step c) the at least one compensated detector signal is determined by using Equation (1):

$${S}_{comp} ( {T}_{0} , λ ) = S ( {T}_{0} + Δ T , λ ) ( 1 - \frac{Γ {γ}_{R} Δ T}{α ( {T}_{0} , λ ) + Γ {γ}_{R} Δ T} ) , \qquad ( 1 )$$

wherein S_{comp}(T₀,λ) refers to the compensated detector signal at a first temperature T₀ of the at least one detector element, wherein λ refers to a wavelength of optical radiation illuminating the at least one detector element, wherein S(T₀+ΔT,λ) refers to a bright detector signal at a second temperature T₀+ΔT of the at least one detector element, wherein ΔT refers to a temperature change of the at least one detector element, wherein α(T₀,λ) refers to a resistive responsivity of the at least one detector element at the first temperature T₀ of the at least one detector element, wherein Γ is defined as

$$Γ = \frac{{γ}_{α}}{{γ}_{R}} ,$$

wherein γ_{α} refers to a predetermined resistive responsivity coefficient of the at least one detector element and wherein γ_{R} refers to a predetermined dark resistance coefficient of the at least one detector element.

Embodiment 3: The method according to the preceding Embodiment, wherein ΔT is below 10 K, specifically below 1 K, more specifically below 0.1 K.

Embodiment 4: The method according to any one of the two preceding Embodiments, wherein at least one of γ_{α} or γ_{R} is predetermined in at least one calibration process of the at least one detector element.

Embodiment 5: The method according to any one of the three preceding Embodiments, wherein γ_{R}ΔT is determined by using at least one baseline of the at least one detector element.

Embodiment 6: The method according to any one of the four preceding Embodiments, wherein γ_{R}ΔT is determined by using the at least one dark detector resistance.

Embodiment 7: The method according to the preceding Embodiment, wherein γ_{R}ΔT is determined by using Equation (2):

$${γ}_{R} Δ T = {R}_{D} ( {T}_{0} + Δ T ) - {R}_{D} ( {T}_{0} ) , \qquad ( 2 )$$

wherein R_{D} refers to the at least one dark detector resistance.

Embodiment 8: The method according to any one of the six preceding Embodiments, wherein Γ is predetermined in a calibration process of at least one of the at least one detector element or at least one further detector element, wherein the at least one detector element and the at least one further detector element are selected from an identical class of detector elements.

Embodiment 9: The method according to any one of the preceding Embodiments, wherein step a) comprises covering the at least one detector element with at least one object.

Embodiment 10: The method according to any one of the preceding Embodiments, wherein the at least one photodetector comprises the at least one of the evaluation unit or a communication interface configured for transmitting data at least one of from or to or within the evaluation unit.

Embodiment 11: The method according to any one of the preceding Embodiments, wherein the at least one evaluation unit is at least partially cloud-based.

Embodiment 12: The method according to any one of the preceding Embodiments, wherein the method is at least partially computer-implemented.

Embodiment 13: A method for determining at least one item of measurement information on at least one measurement object by using at least one photodetector, wherein the at least one photodetector comprises at least one detector element configured for generating at least one detector signal depending on an illumination of the at least one detector element, the method comprising the following steps:
i) providing optical radiation by using the at least one measurement object and generating at least one detector signal by using the at least one photodetector;
ii) determining at least one compensated detector signal according to any one of the preceding Embodiments; and
iii) determining at least one item of measurement information on the at least one measurement object by using the at least one compensated detector signal.

Embodiment 14: The method according to the preceding Embodiment, wherein in step i) the optical radiation provided by the at least one measurement object comprises a wavelength of 300 nm to 3000 nm, specifically 500 nm to 2500 nm, more specifically 1400 nm to 2000 nm.

Embodiment 15: The method according to any one of the preceding Embodiments referring to a method for determining at least one item of information on a measurement object, wherein in step iii) the at least one item of measurement information comprises at least one of a physical property of the at least one measurement object or a chemical composition of the at least one measurement object.

Embodiment 16: The method according to any one of the preceding Embodiments referring to a method for determining at least one item of information on a measurement object, wherein the method is at least partially computer-implemented.

Embodiment 17: A computer program comprising instructions which, when the computer program is executed by a computer, cause the computer to carry out at least one of the methods according to any one of the preceding method Embodiments.

Embodiment 18: A non-transient computer-readable medium including instructions that, when executed by one or more processors, cause the one or more processors to perform at least one of the methods according to any one of the preceding method Embodiments.

Embodiment 19: A photodetector for measuring optical radiation, wherein the photodetector is configured for performing at least one method according to any one of the preceding Embodiments referring to at least one of
a method for determining at least one compensated detector signal of at least one photodetector; or
a method for determining at least one item of measurement information on at least one measurement object, wherein the photodetector comprises at least one detector element.

Embodiment 20: The photodetector according to the preceding Embodiment, further comprising at least one readout circuit configured for reading out the at least one detector signal.

Embodiment 21: The photodetector according to the preceding Embodiment, wherein the at least one readout circuit comprises at least one resistance meter configured for measuring at least one resistance of the at least one detector element.

Embodiment 22: The photodetector according to any one of the preceding Embodiments referring to a photodetector, wherein the at least one detector element comprises at least one photoconductive material.

Embodiment 23: The photodetector according to the preceding Embodiment, wherein the photoconductive material is selected from at least one of PbS, PbSe, Ge, InGaAs, InSb, or HgCdTe.

Embodiment 24: The photodetector according to any one of the preceding Embodiments referring to a photodetector, wherein the at least one photodetector comprises at least one of an evaluation unit or a communication interface configured for transmitting data at least one of from or to or within the evaluation unit.

Embodiment 25: The photodetector according to any one of the preceding Embodiments referring to a photodetector, wherein the at least one evaluation unit is at least partially cloud-based.

Embodiment 26: A spectrometer for spectrally analyzing optical radiation provided by at least one measurement object, the spectrometer comprising:
at least one radiation emitting element configured for emitting optical radiation at least partially towards the at least one measurement object; and
at least one photodetector according to any one of the preceding Embodiments referring to a photodetector.

Embodiment 27: The spectrometer according to the preceding Embodiment, wherein the at least one radiation emitting element comprises at least one of a semiconductor-based radiation source or a thermal radiator.

Embodiment 28: The spectrometer according to the preceding Embodiment, wherein the at least one semiconductor-based radiation source is selected from at least one of a light emitting diode (LED) or a laser, specifically a laser diode.

Embodiment 29: The spectrometer according to any one of the preceding Embodiments referring to a spectrometer, further comprising at least one temperature stabilizing element, specifically a thermoelectric cooler.

Embodiment 30: The spectrometer according to any one of the preceding Embodiments referring to a spectrometer, wherein the at least one evaluation unit is further designed to, completely or partially, control or drive the spectrometer or a part thereof.

Embodiment 31: A use of at least one of a method for determining at least one item of measurement information on a measurement object according to any one of the preceding Embodiments referring to a method for determining at least one item of information on a measurement object or a spectrometer according to any one of the preceding Embodiments referring to a spectrometer for a purpose of use, selected from the group consisting of: an infrared detection application; a spectroscopy application; an exhaust gas monitoring application; a combustion process monitoring application; a pollution monitoring application; an industrial process monitoring application; a mixing or blending process monitoring; a chemical process monitoring application; a food processing process monitoring application; a food preparation process monitoring; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application, in particular characterization of soil, silage, feed, crop or produce, monitoring plant health; a plastics identification and/or recycling application; and a textiles identification and recycling application.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 schematically shows an exemplary embodiment of a spectrometer according to the present invention;

FIG. 2 schematically shows an exemplary embodiment of a photodetector according to the present invention;

FIG. 3 shows a flow chart of an exemplary embodiment of a method for determining at least one compensated detector signal for at least one photodetector according to the present invention;

FIGS. 4, 5A-5F, 6A-6C show experimental results of measurements on an exemplary embodiment of a spectrometer according to the present invention;

FIG. 7 shows a flow chart of an exemplary embodiment of a method for determining at least one item of measurement information on at least one measurement object by using at least one photodetector according to the present invention.

### DETAILED DESCRIPTION OF THE EMBODIMENTS

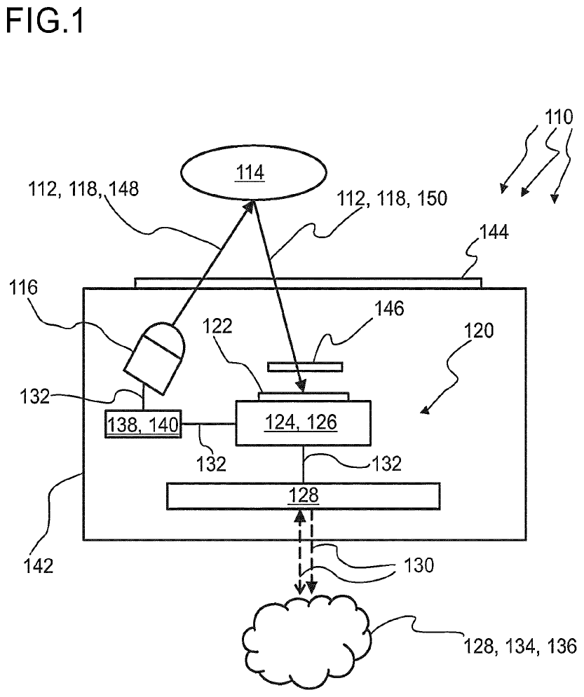

FIG. 1 schematically shows an exemplary embodiment of a spectrometer 110 according to the present invention. The spectrometer 110 is configured for spectrally analyzing optical radiation 112 provided by at least one measurement object 114. The optical radiation 112 provided by the at least one measurement object 114 may comprise a wavelength of 300 nm to 3000 nm, specifically of 500 nm to 2500 nm, more specifically of 1400 nm to 2000 nm. Thus, the optical radiation 112 provided by the at least one measurement object 114 may, specifically, be IR radiation, more specifically NIR radiation. The at least one measurement object 114 may have an arbitrary shape and composition. The at least one measurement object 114 may be a solid sample. However, the at least one measurement object 114 may also be a fluid sample.

The spectrometer 110 comprises at least one radiation emitting element 116 configured for emitting the optical radiation 112 at least partially towards the at least one measurement object 114. The optical radiation 112 emitted by the at least one radiation emitting element 116 may be modulated. The at least one radiation emitting element 116 may comprise at least one of a semiconductor-based radiation source or a thermal radiator. The at least one semiconductor-based radiation source may be selected from at least one of a light emitting diode (LED) or a laser, specifically a laser diode. The at least one radiation emitting element 116 may be configured for emitting the optical radiation 112 isotropically in all spatial directions. The at least one radiation emitting element 116 may be configured for emitting the optical radiation 112 anisotropically in at least one spatial direction, specifically towards the at least one measurement object 114, such as by generating at least one light beam 118.

The spectrometer 110 further comprises at least one photodetector 120 according to any one of the embodiments described above or below in further detail referring to the photodetector 120.

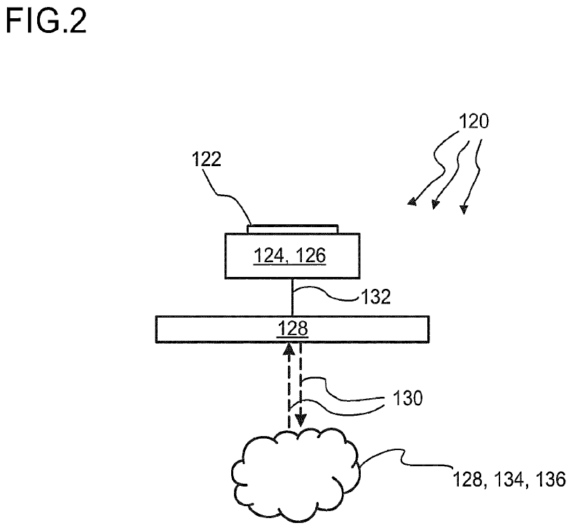

An exemplary embodiment of the photodetector 120 is also schematically shown in FIG. 2 in an isolated fashion. Thus, with respect to the photodetector 120, FIGS. 1 and 2 can be described in conjunction. The photodetector 120 is configured for measuring the optical radiation 112. The photodetector 120 is further configured for performing at least one method according to any one of the embodiments described above or below in further detail referring to at least one of a method for determining at least one compensated detector signal of the at least one photodetector 120, or a method for determining at least one item of measurement information on at least one measurement object 114. The photodetector 120 comprises at least one detector element 122. The at least one detector element 122 may be a photosensitive area of the photodetector 120. The at least one detector element 122 may comprise at least one photoconductive material. The photoconductive material may be selected from at least one of PbS, PbSe, Ge, InGaAs, InSb, or HgCdTe. The photodetector 120 may comprise at least one readout circuit 124. The at least one readout circuit 124 may be configured for reading out at least one detector signal generated by the at least one detector element 122. The at least one readout circuit 124 may comprise at least one resistance meter 126 configured for measuring at least one resistance of the at least one detector element 122. The at least one readout circuit 124 may be connected to further components of the photodetector 120, such as to at least one of an evaluation unit 128 or a communication interface 130, e.g. by using at least one wire 132.

The photodetector 120 may comprise at least one of an evaluation unit 128 or a communication interface 130 configured for transmitting data at least one of from or to or within the evaluation unit 128. The at least one evaluation unit 128 may at least partially be cloud-based. In other words, the at least one evaluation unit 128 may at least partially be distributed in at least one cloud 134 used for at least one of cloud computing or cloud storage. The at least one cloud 134 may specifically comprise at least one external device 136, e.g. a computer or a computer network. As shown in FIGS. 1 and 2, the at least one evaluation unit 128 may at least partially be distributed within the photodetector 120, e.g. for a first signal processing of the detector signal read out by the at least one readout circuit 124, such as for a signal filtering or a signal smoothening. Further signal processing or signal evaluation may be performed in a part of the at least one evaluation unit 128 distributed over the at least one external device 136 of the at least one cloud 134. The at least one external device 136 may specifically comprise more computing power or data storage volume. Additionally or alternatively, the at least one external device 136 may be more user-friendly or mobile, such as a smart phone. The different parts of the at least one evaluation unit 128 may at least partially be interconnected by the at least one communication interface 130. The communication interface 130 may be at least one of wireless or wire-bound.

The spectrometer 110 may further comprise at least one temperature stabilizing element 138, specifically a thermoelectric cooler 140. The at least one temperature stabilizing element 138 may specifically be configured for stabilizing a temperature of the spectrometer 110 or at least a part thereof, such as at least one of the at least one radiation emitting element 116 or the photodetector 120. As FIG. 1 shows, the at least one temperature stabilizing element 138 may be connected to at least one of the radiation emitting element 116 or to the photodetector 120 for heat transfer, e.g. by at least one wire 132. The at least one evaluation unit 128 may further be designed to, completely or partially, control or drive the spectrometer 110 or a part thereof, such as at least one of the temperature stabilizing element 138, the at least one radiation emitting element 116 or the photodetector 120. The spectrometer 110 may further comprise at least one housing 142 surrounding at least parts of the spectrometer 110, such as at least one of the temperature stabilizing element 138, the radiation emitting element 116 or the photodetector 120. The at least one external device 136 of the at least one cloud 134 may be arranged outside of the at least one housing 142. The at least one housing 142 may comprise at least one window 144. The at least one window 144 may at least partially be transparent for the optical radiation 112. The spectrometer 110 may further comprise at least one filter element 146. The at least one filter element 146 may be configured for filtering the optical radiation 112 or, more specifically, selected wavelengths of the optical radiation 112. The at least one filter element 146 may specifically be positioned in a beam path in front of the at least one detector element 122.

In the following, an exemplary beam path of the optical radiation 112 is described with respect to FIG. 1. The at least one radiation emitting element 116 may emit the optical radiation 112 as incident optical radiation 148 through the at least one window 128 towards the at least one measurement object 114. The at least one measurement object 114 may at least partially, specifically diffusely, reflect the incident optical radiation 148 towards the at least one detector element 122 of the at least one photodetector 120 in form of reflected optical radiation 150.

Further, the at least one measurement object 114 may at least partially absorb the incident optical radiation 148, which may be indicative of at least one physical property or chemical composition of the at least one measurement object 114. The reflected optical radiation 150 may pass the at least one window 144 and the at least one filter element 146 before reaching the at least one detector element 122. The at least one detector element 122 may generate a corresponding detector signal which may be read out by using the at least one readout circuit 124.

As already indicated, FIG. 2 schematically shows an exemplary embodiment of the photodetector 120 according to the present invention. For a description of the photodetector 120, it may largely be referred to the description of the spectrometer 110 above. As said, the photodetector 120 is configured for performing the at least one method according to any one of the embodiments described above or below, in further detail referring to at least one of the method for determining the at least one compensated detector signal of the at least one photodetector 120 or the method for determining the at least one item of measurement information on the at least one measurement object 114.

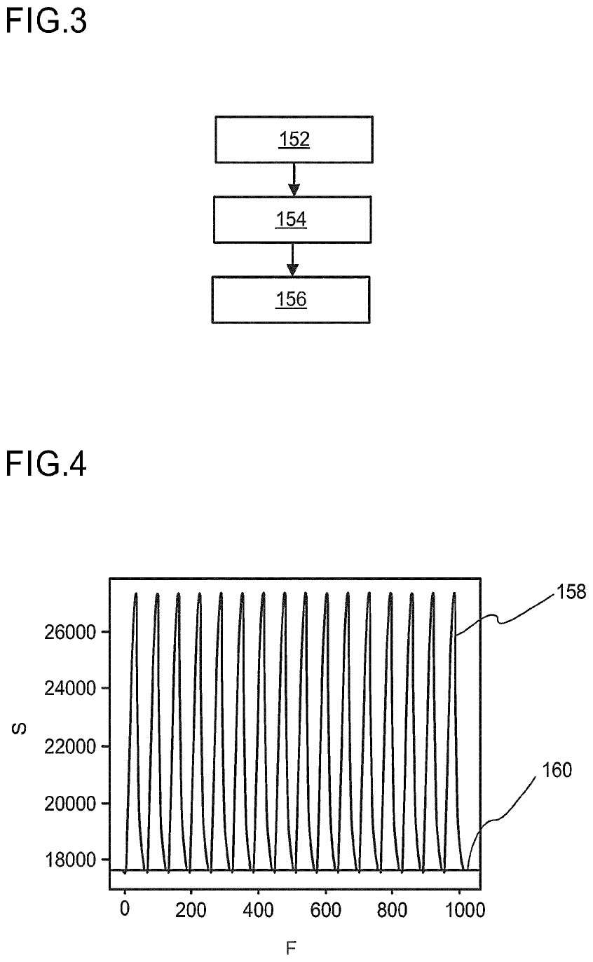

FIG. 3 shows a flow chart of an exemplary embodiment of a method for determining at least one compensated detector signal for the at least one photodetector 120 according to the present invention. The at least one photodetector 120 comprises the at least one detector element 122 configured for generating at least one detector signal depending on an illumination of the at least one detector element 122. The method comprises the following steps:
a) (denoted with reference number 152) determining at least one dark detector resistance by using the at least one detector element 122 and inhibiting illumination of the at least one detector element 122;
b) (denoted with reference number 154) generating at least one bright detector signal by using the at least one detector element 122 and allowing illumination of the at least one detector element 122; and
c) (denoted with reference number 156) determining at least one compensated detector signal for compensating at least one temperature drift of the at least one detector element 122 by using the at least one evaluation unit 128 for evaluating the at least one dark sensor resistance and the at least one bright detector signal.

The method steps may be performed in the indicated order. It shall be noted, however, that a different order is also possible. The method may comprise further method steps which are not listed herein. Further, one or more of the method steps may be performed once or repeatedly. Further, two or more of the method steps may be performed simultaneously or in a timely overlapping fashion. The method steps may at least partially be computer-implemented.

In step c) the at least one compensated detector signal may be determined by using Equation (1):

$${S}_{comp} ( {T}_{0} , λ ) = S ( {T}_{0} + Δ T , λ ) ( 1 - \frac{Γ {γ}_{R} Δ T}{α ( {T}_{0} , λ ) + Γ {γ}_{R} Δ T} ) , \qquad ( 1 )$$

wherein S_{comp}(T₀,λ) refers to the compensated detector signal at a first temperature T₀ of the at least one detector element 122, wherein λ refers to a wavelength of the optical radiation 112 illuminating the at least one detector element 122, wherein S(T₀+ΔT,λ) refers to a bright detector signal at a second temperature T₀+ΔT of the at least one detector element 122, wherein ΔT refers to a temperature change of the at least one detector element, wherein α(T₀,λ) refers to a resistive responsivity of the at least one detector element 122 at the first temperature T₀ of the at least one detector element 122, wherein Γ is defined as

$$Γ = \frac{{γ}_{α}}{{γ}_{R}} ,$$

wherein γ_{α} refers to a predetermined resistive responsivity coefficient of the at least one detector element 122 and wherein γ_{R} refers to a predetermined dark resistance coefficient of the at least one detector element 122. ΔT may be below 10 K, specifically below 1 K, more specifically below 0.1 K. At least one of γ_{α} or γ_{R} may be predetermined in at least one calibration process of the at least one detector element 122. γ_{R}ΔT may be determined by using at least one baseline of the at least one detector element 122. γ_{R}ΔT may be determined by using the at least one dark detector resistance. γ_{R}ΔT may be determined by using Equation (2):

$${γ}_{R} Δ T = {R}_{D} ( {T}_{0} + Δ T ) - {R}_{D} ( {T}_{0} ) , \qquad ( 2 )$$

wherein R_{D} refers to the at least one dark detector resistance. Γ may be predetermined in a calibration process of at least one of the at least one detector element 122 or at least one further detector element, wherein the at least one detector element 122 and the at least one further detector element may be selected from an identical class of detector elements.

Step a) may comprise covering the at least one detector element 122 with at least one object. However, step a) may, additionally or alternatively, comprise not illuminating the at least one detector element 122. As said, the optical radiation 112 emitted by the at least one radiation emitting element 116 may be modulated. Thus, the optical radiation 112 received by the at least one detector element 122 may be modulated, as will be further described with respect to FIG. 4. This can be used for determining the dark detector resistance of the at least one detector element 122 also without covering the at least one detector element 122.

FIGS. 4, 5A to 5F, and 6A to 6C show experimental results of measurements using an exemplary embodiment of a spectrometer 110 according to the present invention. FIG. 4 shows a detector signal 158, which may be typical of a detector element 122 comprising a photoconductive material. The detector signal 158 was obtained by using optical radiation 112 emitted by a modulated radiation emitting element 116. The detector signal 158 is a signal S which was measured in counts over time, specifically over 1000 frames F. The detector signal 158 may show a periodic progression due to the modulation of the radiation emitting element 116. The maxima of the detector signal 158 may correspond to phases of illumination of the detector element 122 and thus to bright detector signals. The minima of the detector signal 158 may correspond to phases of no illumination of the detector element 122 and, thus, to dark detector signals. A baseline 160 was fit to the minima of the detector signal 156. The baseline 160 may directly correspond to the dark detector resistance R_{D} of the detector element 122. The baseline 160 and also the maxima of the detector signal 158, i.e. the bright detector signals, may show a temperature dependence for fixed wavelength and spectral irradiance.

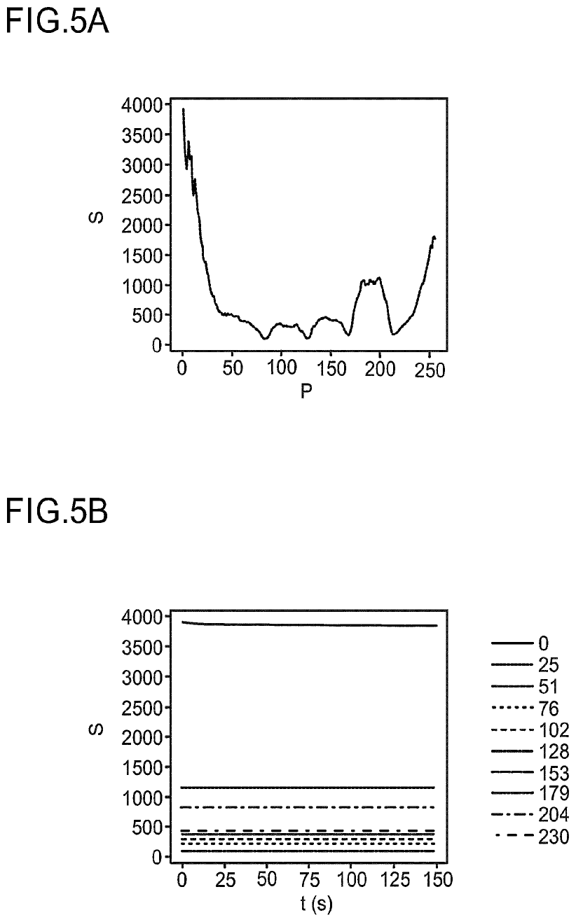

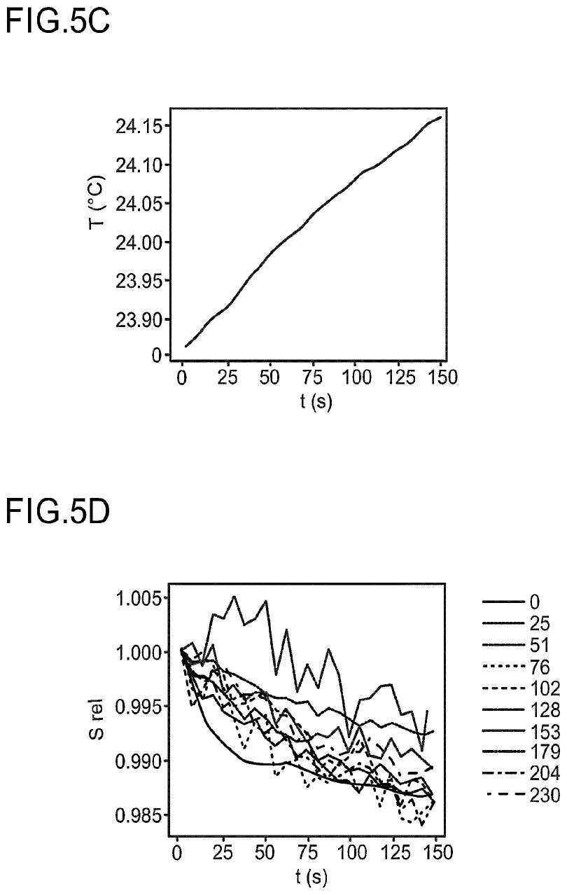

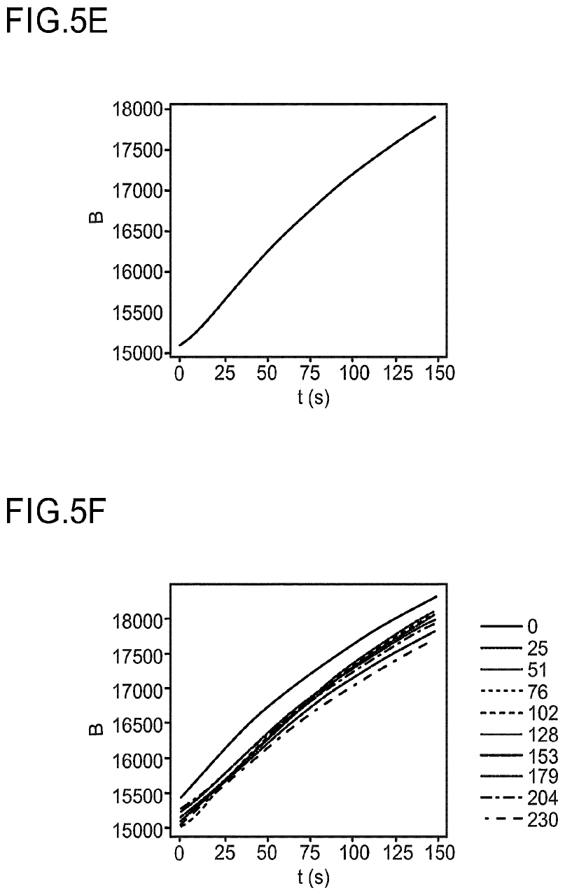

FIGS. 5A to 5F show examples of temperature drifts. FIG. 5A shows a measurement signal for a photodetector 120 comprising 256 detector elements 122 arranged within a detector array. In such an arrangement, the detector elements 122 may typically be referred to as pixels P. Thus, the measurement signal comprises mean bright detector signals for each pixel. FIG. 5B shows bright detector signals for selected pixels over a time t of 150 s, within which the bright detector signals show a decrease. Each shown line represents a bright detector signal of one of the selected detector elements 122. The decrease is again related to a temperature increase. FIG. 5C shows the increase of the temperature T of the photodetector 120 at the same time. FIG. 5D shows the bright detector signals from FIG. 5B relative to their respective initial value at 0 s. The relative signals Sᵣₑi underline the temperature-dependent decrease of the bright detector signal. Further, also the dark detector signals show a temperature dependence. Specifically, the temperature drifts in the dark detector signal are proportional to the temperature. FIGS. 5E and 5F show corresponding baselines B. FIG. 5E shows that a mean baseline shifts proportional to the temperature. FIG. 5F further shows that the baselines shift proportional to the temperature for the selected detector elements 122.

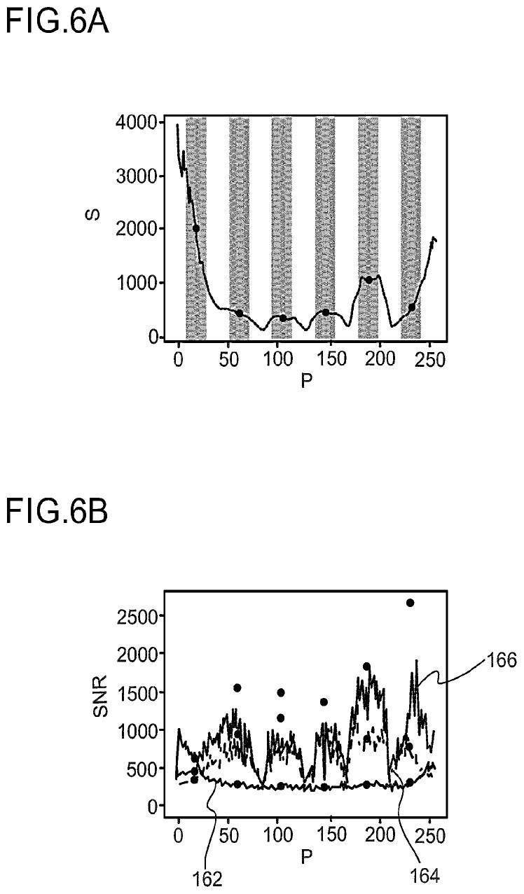

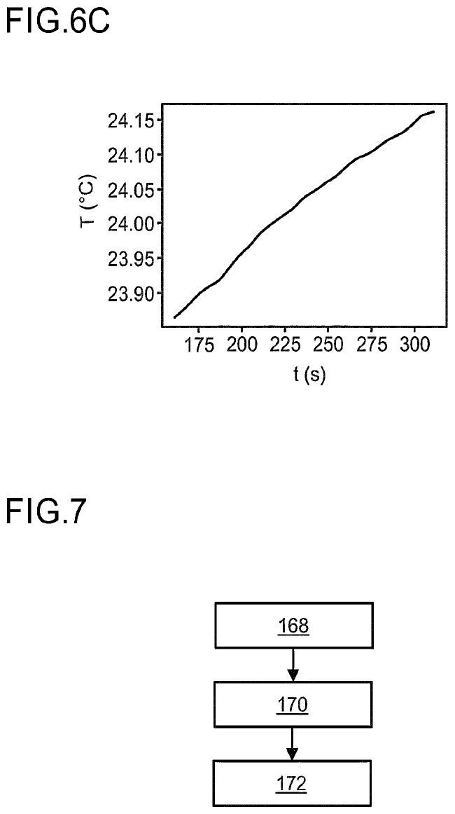

The temperature drifts can be avoided by using the proposed method for determining the at least one compensated detector signal. FIGS. 6A to 6C show experimental data corresponding to an application of the proposed temperature compensation scheme. FIG. 6A again shows the measurement signal of FIG. 5A. Dots indicate a clustering of multiple pixels to a single data point by determining mean values. FIG. 6B shows that applying the proposed temperature compensation scheme can improve the signal to noise ratio (SNR) significantly. Specifically, a baseline-based temperature compensation was applied, which outperformed an application of an external sensor. The SNR of the uncompensated measurement signal is denoted with reference number 162. The SNR of the measurement signal which was compensated by using an external sensor is denoted with reference number 164. The SNR of the measurement signal which was compensated by using the baseline-based temperature compensation is denoted with reference number 166. The dots refer to the respective clusters indicated in FIG. 6A. As can be seen, for almost all pixels, the measurement signal which was compensated by using the proposed temperature compensation shows the highest SNR over all. FIG. 6C again shows the temporal temperature progression of the photodetector 120.

The discussed temperature compensation scheme may specifically be applied when performing measurements on the at least one measurement 114. FIG. 7 shows a flow chart of an exemplary embodiment of a method for determining at least one item of measurement information on the at least one measurement object 114 by using the at least one photodetector 120 according to the present invention. As said, the at least one photodetector 120 comprises at least one detector element 122 configured for generating at least one detector signal depending on an illumination of the at least one detector element 122. The method comprises the following steps:
i) (denoted with reference number 168) providing the optical radiation 112 by using the at least one measurement object 114 and generating at least one detector signal by using the at least one photodetector 120;
ii) (denoted with reference number 170) determining at least one compensated detector signal according to any one of the embodiments described above or below in further detail referring to a method for determining at least one compensated detector signal; and
iii) (denoted with reference number 172) determining at least one item of measurement information on the at least one measurement object 114 by using the at least one compensated detector signal.

The method steps may be performed in the indicated order. It shall be noted, however, that a different order is also possible. The method may comprise further method steps which are not listed herein. Further, one or more of the method steps may be performed once or repeatedly. Further, two or more of the method steps may be performed simultaneously or in a timely overlapping fashion. The method steps may at least partially be computer-implemented. The at least one item of measurement information may comprise at least one of a physical property of the at least one measurement object 114 or a chemical composition of the at least one measurement object 114.

### LIST OF REFERENCE NUMBERS

110 spectrometer
112 optical radiation
114 measurement object
116 radiation emitting element
118 light beam
120 photodetector
122 detector element
124 readout circuit
126 resistance meter
128 evaluation unit
130 communication interface
132 wire
134 cloud
136 external device
138 temperature stabilizing element
140 thermoelectric cooler
142 housing
144 window
146 filter element
148 incident optical radiation
150 reflected optical radiation
152 step a)
154 step b)
156 step c)
158 detector signal
160 baseline
162 signal to noise ratio (SNR) of uncompensated measurement signal
164 signal to noise ratio (SNR) of measurement signal compensated by using external sensor
166 signal to noise ratio (SNR) of measurement signal compensated by using baseline-based temperature compensation
168 step i)
170 step ii)
172 step iii)

1. A method for determining at least one compensated detector signal for at least one photodetector, wherein the at least one photodetector comprises at least one detector element configured for generating at least one detector signal depending on an illumination of the at least one detector element, wherein the at least one detector element is configured as a photoconductor, the method comprising the following steps:
a) determining at least one dark detector resistance by using the at least one detector element and inhibiting illumination of the at least one detector element;
b) generating at least one bright detector signal by using the at least one detector element and allowing illumination of the at least one detector element; and
c) determining at least one compensated detector signal for compensating at least one temperature drift of the at least one detector element by using at least one evaluation unit for evaluating the at least one dark sensor resistance and the at least one bright detector signal,
wherein in step c) the at least one compensated detector signal is determined by using Equation (1):
$${S}_{comp} ( {T}_{0} , λ ) = S ( {T}_{0} + Δ T , λ ) ( 1 - \frac{Γ {γ}_{R} Δ T}{α ( {r}_{0} , λ ) + Γ {γ}_{R} Δ T} ) , \qquad ( 1 )$$
wherein S_{comp}(T₀,λ) refers to the compensated detector signal at a first temperature T₀ of the at least one detector element, wherein λ refers to a wavelength of optical radiation illuminating the at least one detector element, wherein S(T₀+ΔT, λ) refers to a bright detector signal at a second temperature T₀+ΔT of the at least one detector element, wherein ΔT refers to a temperature change of the at least one detector element, wherein a temperature change ΔT is determined by measuring the at least one dark detector resistance R_{D} of the at least one detector element, wherein α(T₀,λ) refers to a resistive responsivity of the at least one detector element at the first temperature T₀ of the at least one detector element, wherein Γ is defined as
$$Γ = \frac{{γ}_{α}}{{γ}_{R}} ,$$
wherein γ_{α} refers to a predetermined resistive responsivity coefficient of the at least one detector element, and wherein γ_{R} refers to a predetermined dark resistance coefficient of the at least one detector element.

2. The method according to claim 1, wherein at least one of γ_{α} or γ_{R} is predetermined in at least one calibration process of the at least one detector element.

3. The method according to claim 1, wherein γ_{R}ΔT is determined by using at least one baseline of the at least one detector element.

4. The method according to claim 1, wherein γ_{R}ΔT is determined by using the at least one dark detector resistance.

5. The method according to claim 4, wherein γ_{R}ΔT is determined by using Equation (2):
$${γ}_{R} Δ T = {R}_{D} ( {T}_{0} + Δ T ) - {R}_{D} ( {T}_{0} ) , \qquad ( 2 )$$
wherein R_{D} refers to the at least one dark detector resistance.

6. The method according to claim 1, wherein Γ is predetermined in a calibration process of at least one of the at least one detector element or at least one further detector element, wherein the at least one detector element and the at least one further detector element are selected from an identical class of detector elements.

7. The method according to claim 1, wherein the at least one photodetector comprises the at least one of the evaluation unit or
a communication interface configured for transmitting data at least one of from or to or within the evaluation unit.

8. The method according to claim 1, wherein the at least one evaluation unit is at least partially cloud-based by outsourcing of the at least one evaluation unit or of at least a part thereof to at least partially interconnected external devices.

9. The method according to claim 1, wherein the method is at least partially computer-implemented.

10. The method according to claim 1, wherein the at least one detector element comprises at least one photoconductive material, wherein the photoconductive material is selected from the group consisting of: PbS, PbSe, Ge, InGaAs, InSb, HgCdTe, and combinations thereof.

11. A method for determining at least one item of measurement information on at least one measurement object by using at least one photodetector, wherein the at least one photodetector comprises at least one detector element configured for generating at least one detector signal depending on an illumination of the at least one detector element, the method comprising the following steps:
i) providing optical radiation by using the at least one measurement object and generating at least one detector signal by using the at least one photodetector;
ii) determining at least one compensated detector signal according to claim 1; and
iii) determining at least one item of measurement information on the at least one measurement object by using the at least one compensated detector signal.

12. A non-transient computer-readable medium including instructions that, when executed by one or more processors, cause the one or more processors to at least one of:
determine at least one compensated detector signal for compensating at least one temperature drift of the at least one detector element by using at least one evaluation unit for evaluating the at least one dark sensor resistance and the at least one bright detector signal; or
determine at least one item of measurement information on the at least one measurement object by using the at least one compensated detector signal.

13. A photodetector for measuring optical radiation, wherein the photodetector is configured for performing:
the method for determining at least one compensated detector signal of at least one photodetector according to claim 1;
wherein the photodetector comprises at least one detector element.

14. A spectrometer for spectrally analyzing optical radiation provided by at least one measurement object, the spectrometer comprising:
at least one radiation emitting element configured for emitting optical radiation at least partially towards the at least one measurement object; and
at least one photodetector according to claim 13.

15. A method of using the method for determining at least one item of measurement information on at least one measurement object according to claim 13, the method comprising using the method for a purpose of use selected from the group consisting of: an infrared detection application; a spectroscopy application; an exhaust gas monitoring application; a combustion process monitoring application; a pollution monitoring application; an industrial process monitoring application; a mixing or blending process monitoring; a chemical process monitoring application; a food processing process monitoring application; a food preparation process monitoring; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application, in particular characterization of soil, silage, feed, crop or produce, monitoring plant health; a plastics identification and/or recycling application; and a textiles identification and recycling application.

16. A photodetector for measuring optical radiation, wherein the photodetector is configured for performing the method for determining at least one item of measurement information on at least one measurement object according to claim 11, wherein the photodetector comprises at least one detector element.

17. A spectrometer for spectrally analyzing optical radiation provided by at least one measurement object, the spectrometer comprising:
at least one radiation emitting element configured for emitting optical radiation at least partially towards the at least one measurement object; and
at least one photodetector according to claim 16.

18. A method of using the spectrometer according to claim 14, the method comprising using the spectrometer for a purpose of use selected from the group consisting of an infrared detection application; a spectroscopy application; an exhaust gas monitoring application; a combustion process monitoring application; a pollution monitoring application; an industrial process monitoring application; a mixing or blending process monitoring; a chemical process monitoring application; a food processing process monitoring application; a food preparation process monitoring; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application, in particular characterization of soil, silage, feed, crop or produce, monitoring plant health; a plastics identification and/or recycling application; and a textiles identification and recycling application.

19. A method of using the spectrometer according to claim 17, the method comprising using the spectrometer for a purpose of use selected from the group consisting of an infrared detection application; a spectroscopy application; an exhaust gas monitoring application; a combustion process monitoring application; a pollution monitoring application; an industrial process monitoring application; a mixing or blending process monitoring; a chemical process monitoring application; a food processing process monitoring application; a food preparation process monitoring; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application, in particular characterization of soil, silage, feed, crop or produce, monitoring plant health; a plastics identification and/or recycling application; and a textiles identification and recycling application.
